(19) United States
(12) Patent Application Publication
(10) Pub. No.: US 2005/0057510 A1
(43) Pub. Date: Mar. 17, 2005

(54) Scanning optical mouse

(76) Inventors: Donald A. Baines, North Wales, PA (US); Jack Kratzer Keller, Zionsville, PA (US); Russell Mark Richman, Schnecksville, PA (US)

Correspondence Address: STRAUB & POKOTYLO, 620 TINTON AVENUE, BLDG. B, 2ND FLOOR, TINTON FALLS, NJ, 07724, US

(21) Appl. No.: 10/663,209

(22) Filed: Sep. 16, 2003

(51) Int. Cl. G09G 5/00

(52) U.S. Cl. 345/166

(57) ABSTRACT

An optical mouse scanner allows users to perform quick scans of paper documents (or of some other surface) without requiring a separate, standalone scanner. Scanning functionality may be provided to an optical mouse, such as a wireless optical mouse. The scanning sensor and/or the scanning light source could be same as that used for the optical motion detection for the mouse. Alternatively, a separate light source and/or imaging element could be provided for purposes of scanning. Image stitching software could use a number of captured images (e.g., a stream of captured frames) alone, or in association with mouse orientation and/or position information, to assemble a larger image from smaller captured image frames.

### § 1. BACKGROUND

§ 1.1 Field of the Invention

The present invention concerns scanning information from a hard copy. More specifically, the present invention concerns providing positioning (e.g., for moving a cursor on a display screen) and scanning functionality in a single unit.

§ 1.2 Related Art

The development and use of mice and scanners are introduced below in §§ 1.2.1 and 1.2.2, respectively.

§ 1.2.1 The Development and Use of Mice

With the advent of the graphical user interface (“GUI”), various devices for positioning a cursor on a display screen have been developed. The most popular of these has been the so-called “mouse.”

Initially, conventional mice were mainly mechanical devices. A mechanical mouse typically has a bottom surface with downward projecting pads of a low friction material that function to raise the bottom surface a short distance above the work surface of a cooperating mouse pad, as well as a centrally located hole through which a portion of the underside of a rubber-surfaced steel ball extends. Gravity pulls the ball downward and against the top surface of the mouse pad. The low friction pads slide easily over the mouse pad, but the rubber ball does not skid. Instead, it rolls as the mouse is moved. Inside the mouse, rollers or wheels contact the ball and convert its rotation into electrical signals. As the mouse is moved, the resulting rotations of the wheels or contact rollers produce electrical signals representing motion components. These electrical signals are converted to changes in the displayed position of a pointer (cursor) in accordance with movement of the mouse. Once the pointer on the screen points at an object or location of interest, a button on the mouse can be pressed, thereby issuing an instruction to take some action, the nature of which is defined by the software in the computer.

Optical mice have been developed to address a number of shortcomings of mechanical mice. For example, the ball of a mechanical mouse can deteriorate or become damaged, and/or the rotation of the contact wheels or rollers can become adversely affected by an accumulation of dirt and/or lint. The wear, damage and/or fouling of these mechanical components often contribute to erratic performance, or even total failure of the mouse.

Although optical mice are well known (See, for example, U.S. Pat. Nos. 5,578,813, 5,644,139, 5,786,804, and 6,281,882, each incorporated herein by reference.), their operation is introduced here for the convenience of the reader. An optical mouse uses an array of sensors to capture images of the various particular spatial features of a work surface below the mouse to optically detect motion. This may involve two basic steps—capturing frames (“imaging”) and determining movement (“tracking”).

Frames are typically captured as follows. The work surface below the imaging mechanism is illuminated from the side (e.g., with an infrared (“IR”) light emitting diode (“LED”)). When so illuminated, micro textures in the surface create a collection of highlights and shadows. IR light reflected from the micro-textured surface is focused onto a suitable array (e.g., 16-by-16 to 24-by-24) of photo detectors. The responses of the individual photo detectors are digitized to a suitable resolution and stored as a frame.

Tracking is typically accomplished by comparing a newly captured sample frame with a previously captured reference frame to ascertain the direction and amount of movement. For example, the entire content of one of the frames may be shifted by a distance of one pixel (which may correspond to a photo detector), successively in each of the eight directions allowed by a one pixel offset candidate shift and another “direction” to indicate no movement. Thus, there are nine candidate shifts. After each candidate shift, those portions of the frames that overlap each other are subtracted on a pixel by pixel basis, and the resulting differences are (e.g., squared and then) summed to form a measure of similarity or “correlation” within that region of overlap. Larger candidate shifts are possible. In any event, the candidate shift with the least difference (greatest correlation) can be taken as an indication of the motion between the two frames. This raw movement information may be scaled and or accumulated to provide display pointer movement information. Other techniques for tracking are possible.

§ 1.2.1 The Development and Use of Scanners

As alluded to above, the mouse has been used to manipulate and/or select information on a display screen. Normally (aside from cut/copy and paste operations), they have not been used to enter information in the first place. Even cut/copy and paste operations operate on information already in digital form. Keyboards, microphones with speech recognition software, imaging devices, etc. have been used for entering information. Relevant to the present invention, scanners are popular imaging devices for entering information into a computer, and include flatbed scanners, sheet-feed scanners and handheld scanners. With flatbed scanners, a lamp (e.g., cold cathode fluorescent, xenon, etc.) is used to illuminate the document being scanned. A scan head, typically including mirrors, lenses, filters and a charge coupled device (“CCD”) array, is moved across the document by a belt driven by a stepper motor. The mirror(s) and lens(es) of the scan head operate to focus an image of the document (or a portion thereof) onto the CCD array. Some scanners use a contact image sensor rather than a scan head including a CCD array.

Handheld scanners use similar technology as flatbed scanners, but rely on a user to move them instead of a motorized belt. Handheld scanners are often used for quickly capturing text, but normally do not provide good image quality. U.S. Pat. No. 6,229,139 (incorporated herein by reference) discusses a handheld document scanner.

Despite their utility, standalone scanners have a number of drawbacks. First, since they are typically a separate peripheral, they often require a specific software application (e.g., image capture and optical character recognition (“OCR”) software) to be used effectively. Moreover, they are just one more peripheral that can clutter a user's desktop.

In many instances, a user just wants the ability to perform a quick scan to input content from paper documents (or from some other physical surface) into electronic documents (e.g., PowerPoint presentations). It would be advantageous to allow such users to perform these types of scans without the clutter associated with an additional peripheral, and/or without the need to install and maintain often complex software applications.

### § 2. SUMMARY OF THE INVENTION

The present invention allows users to perform quick scans of paper documents (or an image on some other physical surface) without requiring a separate, standalone scanner. The present invention does so by imparting scanning functionality to an optical mouse, such as a wireless optical mouse. The scanning sensor and/or the scanning light source could be same as that used for optical motion detection. Alternatively, a separate light source and/or imaging element could be provided in the body of the mouse for purposes of scanning.

OCR software on a host computer could be used to facilitate “cutting and pasting” scanned text.

Image stitching software could use a number of captured images (e.g., a stream of captured frames) alone (in which case at least some of the captured frames overlap), or in association with mouse orientation and/or position information, to assemble a larger image from smaller captured image frames. In this way, the present invention permits a user to capture an image larger than any frame captured by the image sensor.

The present invention may also be used with a mouse which uses a mechanical positioning system. However, such an embodiment might not provide the same level of precision and leveraging of existing components as an embodiment using an optical positioning system.

### § 3. BRIEF DESCRIPTION OF THE DRAWINGS

FIG. 1 is a bubble chart of operations that may be performed in a manner consistent with the present invention.

FIG. 2 is a diagram of a first exemplary embodiment of the present invention.

FIG. 3 is a diagram of a second exemplary embodiment of the present invention.

FIG. 4 is a diagram of a third exemplary embodiment of the present invention.

FIG. 5 is a diagram of a fourth exemplary embodiment of the present invention.

FIGS. 6 and 7 are diagrams illustrating an operation of an exemplary embodiment of the present invention.

### § 4. DETAILED DESCRIPTION OF THE INVENTION

The present invention involves novel methods and apparatus for inputting information from a paper document or some other physical surface. The following description is presented to enable one skilled in the art to make and use the invention, and is provided in the context of particular embodiments and methods. Various modifications to the disclosed embodiments and methods will be apparent to those skilled in the art, and the general principles set forth below may be applied to other embodiments, methods and applications. Thus, the present invention is not intended to be limited to the embodiments and methods shown and the inventors regard their invention as the following disclosed methods, apparatus and materials and any other patentable subject matter to the extent that they are patentable.

§ 4.1 Exemplary Scanning Optical Mouse

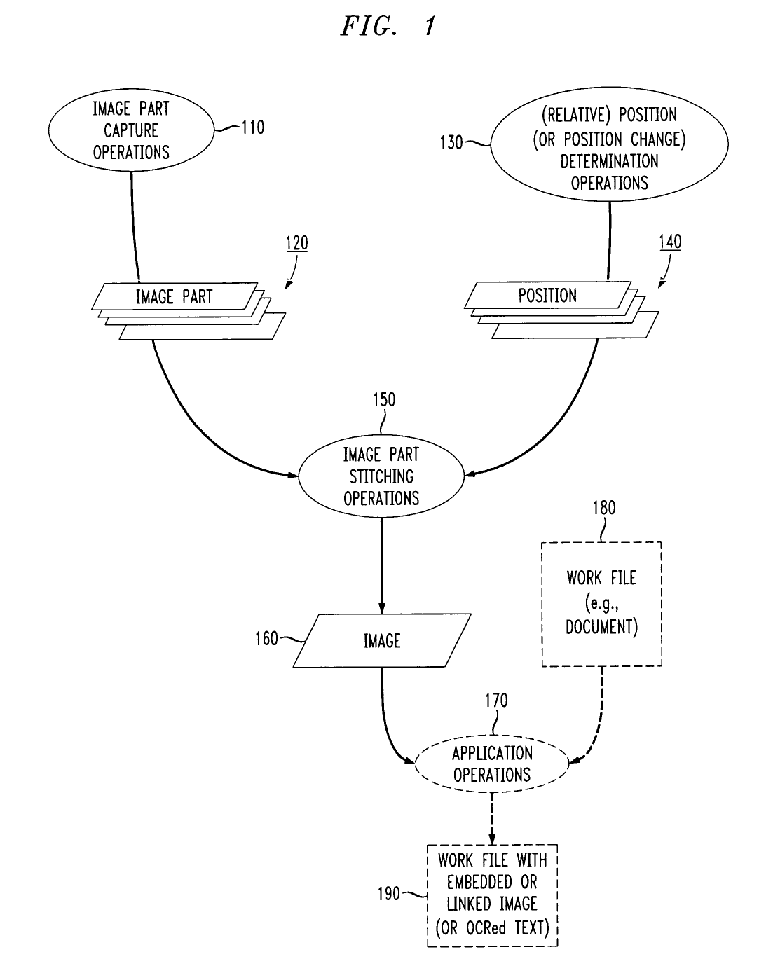

FIG. 1 is a bubble chart of operations that may be performed in a manner consistent with the present invention. Image part capture operations 110 may be used to generate a plurality of image parts (e.g., frames) 120. Position (e.g., relative position) determination operations 130 may be used to generate a plurality of positions (e.g., as X,Y coordinates), or to generate changes in position 140. Each of the plurality of positions 140 may be associated with each of the plurality of image parts 120. Alternatively, at least some of the plurality of positions 140 should be associated with at least some of the plurality of image parts 120. Image part orientation (or change in orientation) information (not shown) may also be determined and saved.

Image part stitching operations 150 may use at least some of the image parts 120 and at least some of the corresponding positions 140 to generate an image 160. The image 160 may be larger than any of the image parts. Interpolation operations (not shown) may use known or proprietary techniques to increase the resolution of the image parts 120 and/or of the image 160.

As shown, application operations 170 used to create and/or edit a work file (e.g., a document) 180 may combine the image 160 and the work file 180 to generate a work file 190 having an embedded or linked image.

In an alternative embodiment of the present invention, the image stitching operations 150 can use the image parts 120, without corresponding position information 140, to generate image 160. In such an alternative embodiment, matching portions of at least partially overlapping image parts are determined so that the position of two image parts, relative to one another, can be determined. In such an alternative embodiment, the position information 140, and therefore the position determination operations 130, are not needed.

As will be appreciated from the following, the position determination operations 130 may be performed using known optical (or even mechanical) mouse technology. The image part capture operations 110 may be performed (a) with the same components used for position determination, (b) with at least some of the components used for position determination, or (c) with its own components.

§ 4.1.1 Exemplary Environment

The present invention may be used in conjunction with a computer, such as desktop personal computer, a laptop, etc. Software for performing image part stitching operations 150 may be performed on the computer, although these operations may be performed by other means and/or in other devices. Components of an optical mouse may be used to perform image part capture operations 110 and/or position determination operations 130. The optical mouse may communicate with the computer via cable, or via some wireless means (e.g., infrared (IR) signals, radio frequency (RF) signals, etc.)

The scan mode of the optical mouse could be selected by the user (e.g., by pressing or pressing and holding a mouse button, by selecting a GUI button, etc.).

§ 4.1.2 First Embodiment

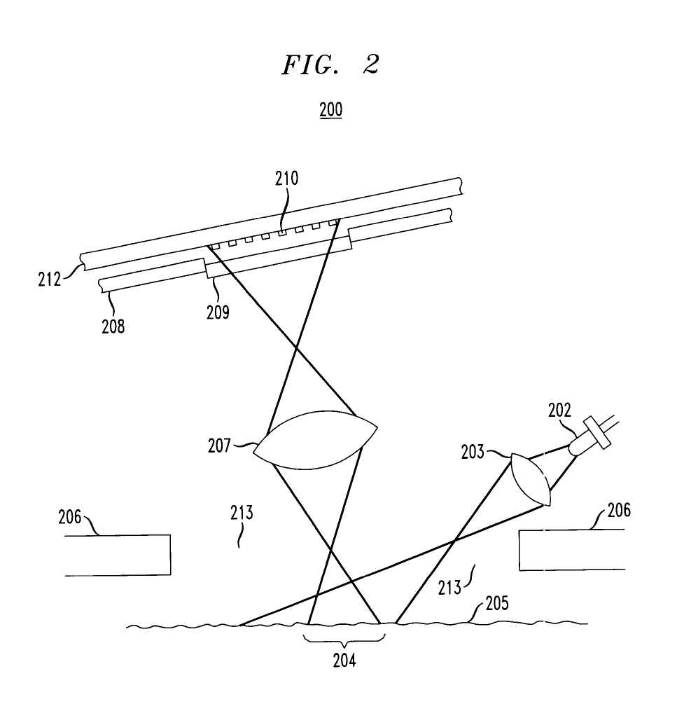

FIG. 2 is a diagram of a first exemplary embodiment 200 of the present invention. In the first embodiment 200, the image part capture operations 110 and position determination operation 130 share a light source and an image pickup device. A lens 203 projects light emitted from a light source (e.g., LED, IR LED, etc.) 202, through a window or opening 213 in a bottom surface 206 of a mouse and onto a region 204 that is part of a document (or some other surface having micro textures) 205 being scanned.

An image of illuminated region 204 is projected by lens 207 through an optical window 209 in package portion 208 of an integrated circuit and onto an imaging device (e.g., an array of photo detectors such as a CCD) 210. The window 209 and lens 207 may be combined. The imaging device 210 may comprise a 12-by-12 through 24-by-24 square array. Arrays having other shapes, sizes and resolutions are possible.

In this first embodiment 200, the light source 202, imaging device 209, as well as other associated elements, are used in the performance of both image part capture operations 110 and position (or position change) determination operations 130.

§ 4.1.3 Second Embodiment

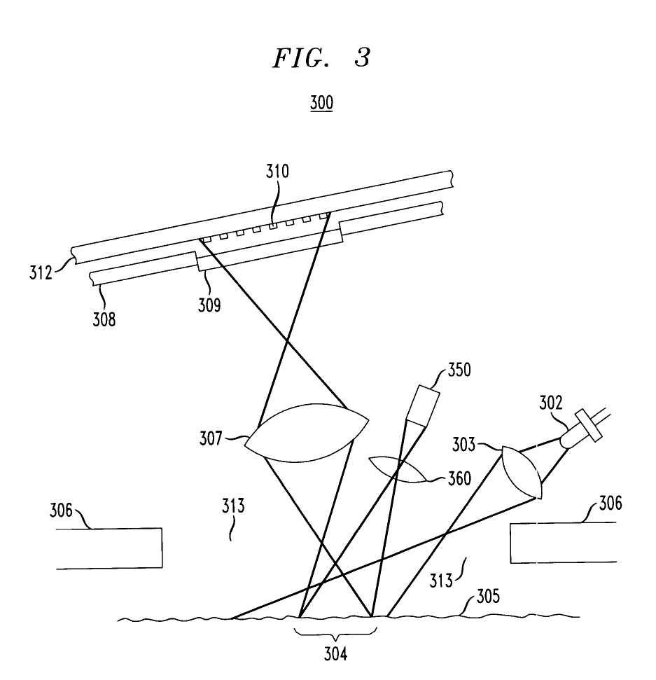

FIG. 3 is a diagram of a second exemplary embodiment 300 of the present invention. The second exemplary embodiment 300 is similar to the first 200, but uses a separate light source 350 for illuminating a document (or some other surface being scanned) 305 for purposes of scanning. Light from the additional light source 350 may be projected onto the document (or some other surface) 305 being scanned at an angle of incidence greater than that of light source 302. A lens 360 may also be provided, but such a lens 360 is not strictly necessary. The light sources 302 and 350 may controlled to emit light in an alternating fashion—when light source 302 is emitting, captured images are used for position determination, while when light source 350 is emitting, captured images are used for image part capture (scanning).

§ 4.1.4 Third Embodiment

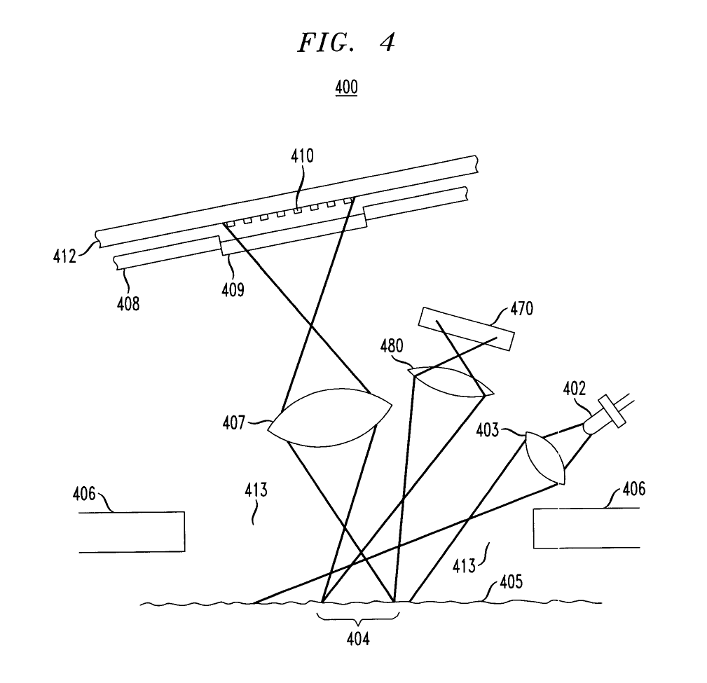

FIG. 4 is a diagram of a third exemplary embodiment 400 of the present invention. The third exemplary embodiment 400 is similar to the first 200, but uses a separate image pickup device 470 for purposes of image part capture (scanning) operations. Light reflected from the surface of the document (or other surface) 405 being scanned may be projected onto the separate image pickup device 470 using lens 480.

In one refinement of this embodiment 400, light emitted from the light source 402 may be made to hit the surface of the document (or some other surface) 405 at different angles of incidence—a smaller angle of incidence for purposes of position determination using imaging device 410, and a larger angle of incidence for purposes of image part capture (scan) using imaging device 470.

In an alternative or further refinement of this embodiment 400, the light source 402 may be made to emit different types (e.g., tuned or modulated wavelength, polarization, amplitude, etc.) of light—one for purposes of position determination using imaging device 410, and another for purposes of image part capture (scan) using imaging device 470.

The imaging device 470 may have a different size and/or shape than the image sensor 410. For example, it may be larger and/or have a more linear arrangement.

§ 4.1.5 Fourth Embodiment

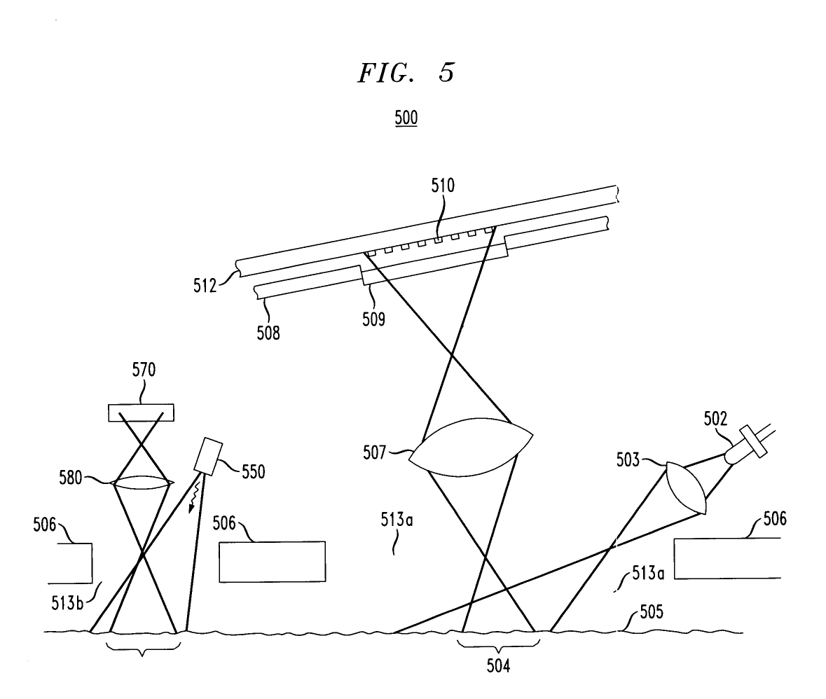

FIG. 5 is a diagram of a fourth exemplary embodiment 500 of the present invention. Like the second embodiment 300, this embodiment 500 includes a separate light source 550, and like the third embodiment 400, this embodiment 500 includes a separate imaging device 570. Although not necessary, at any given time, different portions of the document (or some other surface) 505 being scanned may be imaged for purposes of position determination and scanning. Within the mouse housing (not shown), these separate elements may be optically shielded from one another, although this is not necessary.

§ 4.2 Example of Operations

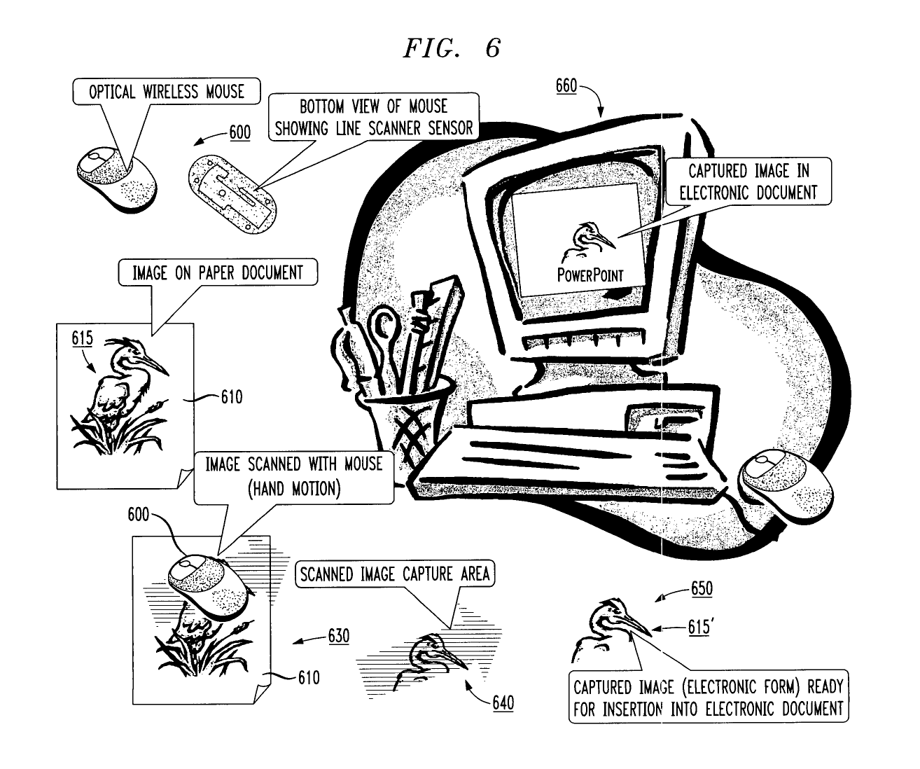

FIG. 6 illustrates a sequence of operations of an embodiment consistent with the present invention. As shown in section 630, an optical mouse 600 is passed over a paper document 610 including image 615. Section 640 illustrates the image capture area scanned. Section 650 illustrates the captured image 615′, which may be input to the computer 660.

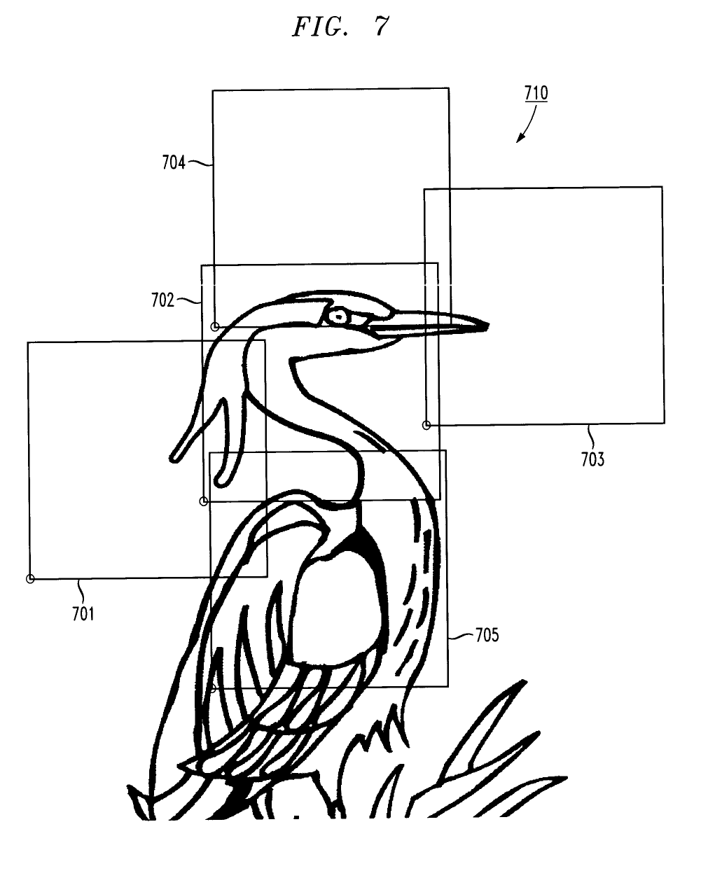

FIG. 7 illustrates examples of a sequence of frames 701-705 that may have been captured and used to compose a larger image 710. Note that each of the frames 701-705 includes a position coordinate in it lower right corner (although alternative coordinate systems could be used). An image part orientation (or orientation change) may also be determined. In practice, many more frames than the five 701-705 shown would be captured and used for scanning. In such a case, the frames could be sampled, with only a portion of the total number of frames being used to stitch together an image 710.

§ 4.3 Conclusions

The present invention permits users to quickly scan an image on a paper document or other media surface without an additional peripheral since most computer's have a GUI interface and the most prevalent pointing device is a mouse. Further, since some embodiments of the present invention leverage already existing components of an optical mouse, the scanning functionality can potentially be added at a low cost. The familiar cut/copy and paste mouse manipulation can be used in a scan and paste operation, but instead of a select, copy, and paste in the electronic domain, a selection operation is performed in the physical domain, while converting/copying and pasting operations are performed in the electronic domain. The present invention advantageously lends itself to the act of selecting in the physical domain, whereas a typical scanner converts without selection.

1. A method comprising:
a) capturing a plurality of image parts;
b) determining position information corresponding to each of the plurality of image parts; and
c) generating image information using, at least, the plurality of image parts and the corresponding position information.

2. The method of claim 1 wherein the position information includes coordinate information.

3. The method of claim 1 wherein the position information includes change of position information.

4. The method of claim 1 wherein the act of capturing a plurality of image parts includes focusing light reflected from a surface onto an imaging device, and
wherein the act of determining position information includes accepting, by the imaging device, light reflected from the surface.

5. The method of claim 4 wherein the light reflected from the surface is emitted from a single light source.

6. The method of claim 4 wherein the light reflected from the surface is emitted from a first light source and a second light source,
wherein the light emitted from the first light source and reflected from the surface onto the imaging device is used in the act of capturing a plurality of image parts, and
wherein the light emitted from the second light source and reflected from the surface onto the imaging device is used in the act of determining position information.

7. The method of claim 6 wherein the light emitted from the first light source has a larger angle of incidence with the surface than the light emitted from the second light source.

8. The method of claim 1 wherein the act of capturing a plurality of image parts includes focusing light reflected from a surface onto a first imaging device, and
wherein the act of determining position information includes focusing light reflected from the surface onto a second imaging device.

9. The method of claim 8 wherein the light reflected from the surface is emitted from a single light source.

10. The method of claim 8 wherein the light reflected from the surface is emitted from a first light source and a second light source,
wherein the light emitted from the first light source and reflected from the surface onto the imaging device is used in the act of capturing a plurality of image parts, and
wherein the light emitted from the second light source and reflected from the surface onto the imaging device is used in the act of determining position information.

11. The method of claim 10 wherein the light emitted from the first light source has a larger angle of incidence with the surface than the light emitted from the second light source.

12. Apparatus comprising:
a) means for capturing a plurality of image parts;
b) means for determining position information corresponding to each of the plurality of image parts; and
c) means for generating image information using, at least, the plurality of image parts and the corresponding position information.

13. The apparatus of claim 12 wherein the position information includes coordinate information.

14. The apparatus of claim 12 wherein the position information includes change of position information.

15. The apparatus of claim 12 wherein the position information includes orientation information.

16. The apparatus of claim 12 wherein the position information includes acceleration information.

17. The apparatus of claim 12 wherein the position information includes velocity information.

18. The apparatus of claim 12 wherein the means for capturing a plurality of image parts includes
1) a light source, and
2) an imaging device, and
wherein the means for determining position information includes
1) the light source, and
2) the imaging device.

19. The apparatus of claim 12 wherein the means for capturing a plurality of image parts includes
1) a first light source, and
2) an imaging device, and
wherein the means for determining position information includes
1) a second light source, and
2) the imaging device.

20. The apparatus of claim 12 wherein the first light source and the second light source emit light that illuminates a surface, and
wherein the light emitted from the first light source has a larger angle of incidence with the surface than the light emitted from the second light source.

21. The apparatus of claim 19 wherein the second light source is a light emitting diode.

22. The apparatus of claim 19 wherein the second light source is an infra-red light emitting diode.

23. The apparatus of claim 19 wherein the second light source is a tunable light source able to modulate at least one of wavelength, polarization, and amplitude.

24. The apparatus of claim 12 wherein the means for capturing a plurality of image parts includes
1) a light source, and
2) a first imaging device, and
wherein the means for determining position information includes
1) the light source, and
2) a second imaging device.

25. The apparatus of claim 12 wherein the means for capturing a plurality of image parts includes
1) a first light source, and
2) a first imaging device, and
wherein the means for determining position information includes
1) a second light source, and
2) a second imaging device.
